(19) United States
(12) Patent Application Publication
(10) Pub. No.: US 2010/0013799 A1
(43) Pub. Date: Jan. 21, 2010

(54) TOUCH INPUT DETECTING DISPLAY FILTER AND DISPLAY DEVICE HAVING THE SAME

(75) Inventors: Shin Wook Kim, ChungCheongNam-Do (KR); Dae Chul Park, ChungCheongNam-Do (KR); Gi Mo Yang, ChungCheongNam-Do (KR); Youn Ok Choi, ChungCheongNam-Do (KR); Dong Keun Shin, ChungCheongNam-Do (KR); Dong Hwal Lee, ChungCheongNam-Do (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: SAMSUNG CORNING PRECISION GLASS CO., LTD., Gyeongsangbuk-do (KR)

(21) Appl. No.: 12/503,330

(22) Filed: Jul. 15, 2009

(30) Foreign Application Priority Data
Jul. 18, 2008 (KR) 10-2008-0070129
Feb. 6, 2009 (KR) 10-2009-0009585

(51) Int. Cl. G06F 3/043

(52) U.S. Cl. 345/177

(57) ABSTRACT

A touch input detecting display filter includes a layered body and a vibration detector. The layered body includes a base substrate disposed in front of a display panel, and an optical filter part having an anti-reflecting film layered on the base substrate. The vibration detector is disposed on the layered body. When an object gets in touch with the layered body, the vibration detector detects vibration generated from a touch location of the layered body.

### CROSS-REFERENCE TO RELATED APPLICATION

This application claims the benefit of Korean Patent Application Nos. 10-2008-0070129 and 10-2009-0009585 filed on Jul. 18, 2008 and Feb. 6, 2009, respectively, in the Korean Intellectual Property Office, the disclosure of which is incorporated herein by reference.

### BACKGROUND OF THE INVENTION

1. Field of the Invention

The present invention relates to a touch input detecting display filter which can detect vibration and thereby receive touch input, and a display device having the same.

2. Description of the Related Art

Display devices develop as the society becomes information-oriented. Recently, a variety of display devices such as an LCD (Liquid Crystal Display) device, a PDP (Plasma Display Panel) device, an ELD (Electro Luminescent Display) device, a VFD (Vacuum Fluorescent Display) device, etc was developed. Some of them are being used for various apparatuses.

As one example of display devices, an LCD device is manufactured by fabricating a TFT array substrate and a color filter substrate through a TFT array substrate fabrication process in which a thin film transistor and a pixel electrode are fabricated and through a color filter substrate fabrication process in which a color filter and a common electrode are fabricated, respectively and providing liquid crystal between the TFT array substrate and the color filter substrate through a liquid crystal cell process.

As another example of display devices, a PDP device brings about discharge in the gas between electrodes by supplying direct current or alternating current to the electrodes to create ultraviolet rays. The created ultraviolet rays activate a fluorescent material to makes visible light emitted.

The PDP device has a drawbacks that a large amount of electromagnetic waves and near infrared rays are emitted, the fluorescent material causes high reflection and color purity is bad due to orange light emitted from He or Xe. Accordingly, the PDP device may have bad effects on a human body and cause malfunction of a precise appliance such as a mobile phone or a remote controller, due to the electromagnetic waves and near infrared rays.

Accordingly, it is required to lower the amount of the electromagnetic waves and near infrared rays emitted form the PDP device under an allowable value. For this reason, the PDP device employs a filter which can perform function of blocking the electromagnetic waves and near infrared rays, reducing the reflection, and improving the color purity.

The current trend is towards increasing the size of display devices and the use of outdoor display devices for providing information or advertising.

In the past, display devices were used to provide one-way information. However, nowadays, users can have interactive communication using an input device by which the users can directly input information with the aid of display devices. For example, users can input information by using a remote controller, while watching display devices. As another example, users can input information by directly touching a screen of a touch input device which is placed in front of display devices.

In a related art, a touch input device is provided independently of a display device and therefore has to be coupled to the display device. Accordingly, the sensibility of the touch input device deteriorates, the total thickness of the device increases, and the touch input device tends to separate from the display device as the time goes by.

If an LCD device is used outdoors, the temperature in the display device increases due to solar light, and the phase transition of liquid crystal can occur.

Nowadays, the current trend is towards employing a protective glass to protect the display module in an LCD monitor/TV. However, the protective glass causes condensation in the LCD monitor/TV due to the temperature difference between the inside and the outside thereof. Generally, in a PDP device, the condensation can be easily and quickly removed because the PDP panel emits heat immediately after the power is On. However, in an LCD device, it is difficult to remove the condensation because the LCD panel emits only a small amount of heat.

### SUMMARY OF THE INVENTION

The present invention has been made against this backdrop. One or more objects of the present invention are directed to provide a display filter which can function as an optical filter and at the same time, an information input device.

One object of the present invention is directed to provide a display filter in which a vibration-detecting touch input device is integrated to detect vibration and determine a touch location, and a display device having the same.

Another object of the present invention is directed to provide a display filter which can be made thinner, and a display device having the same.

Still another object of the present invention is directed to provide a display filter having an anti-fog function, and a display device having the same.

Still another object of the present invention is directed to provide a display filter which can block external noise causing a malfunction of an outdoor display device, and a display device having the same.

In order to achieve the above objects, there is provided a touch input detecting display filter, the touch input detecting display filter including: a layered body including a base substrate disposed in front of a display panel displaying an image, and an optical filter part having an anti-reflecting film layered on the base substrate; and a vibration detector disposed on a layered body, the vibration detector detecting vibration generated from a touch location of the layered body, when an object gets in touch with the layered body,.

In an exemplary embodiment of the invention, the vibration detector may include a piezoelectric sensor installed adjacent to a corner of the layered body to detect the vibration.

In an exemplary embodiment of the invention, the optical filter part may further include a conductive film in which a metal thin film and a high-refractive transparent thin film are layered two or more times on a side of the base substrate facing the display panel.

In an exemplary embodiment of the invention, the optical filter part may further include an anti-fog film which prevents the display panel from fogging by moisture present in a space between the display panel and the touch input detecting display filter.

According to the above-described structure, the display filter integrally includes the vibration-detecting touch input device which detects vibration generated from the touch location and receive information input, so a user can input information by direct touch with a display screen while minimizing the thickness of the display filter.

Further, the display filter can detect the touch location using vibration and thereby receive information input, so the display filter does not require an ITO film or the like which is necessary in a resistive touch input device, and can bear scratches or foreign substances. In addition, the display filter can work even by touch with a nonconductor, which has no static electricity and thus can not be used in a capacitive input device.

Further, the base substrate of the display filter also serves as a support of the touch input device while supporting the respective films of the optical filter part, so the thickness of the filter can be minimized.

Further, the conductive film in which the metal thin film and the high-refractive transparent thin film are layered serves to block external noise causing a malfunction of an outdoor display device.

Further, the anti-fog film provided facing the display panel serves to prevent the display panel from fogging.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating a display device having a display filter according to a first embodiment of the present invention;

FIG. 2 is a cross-sectional view illustrating the display filter according to the first embodiment;

FIG. 3 is a cross-sectional view illustrating a display filter according to a second embodiment;

FIGS. 4A and 4B are cross-sectional views illustrating display filters according to third and fourth embodiments;

FIG. 5 is a front view illustrating an example of a sensor which can be used in a display filter of the present invention;

FIG. 6 is a perspective view illustrating an example of a sensor which can be used in a display filter of the present invention;

FIG. 7 is a partial front view illustrating an example of a sensor which can be used in a display filter of the present invention;

FIG. 8 is a partial front view illustrating wires for a sensor which can be used in a display filter of the present invention; and

FIG. 9 is a front view illustrating arrangements of wires and tail for a sensor which can be used in a display filter of the present invention.

### DETAILED DESCRIPTION OF THE EXEMPLARY EMBODIMENT

The present invention will now be described more fully hereinafter with reference to the accompanying drawings, in which exemplary embodiments thereof are shown.

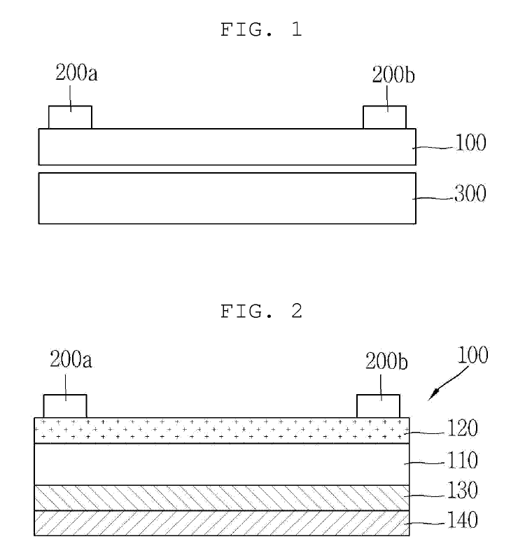

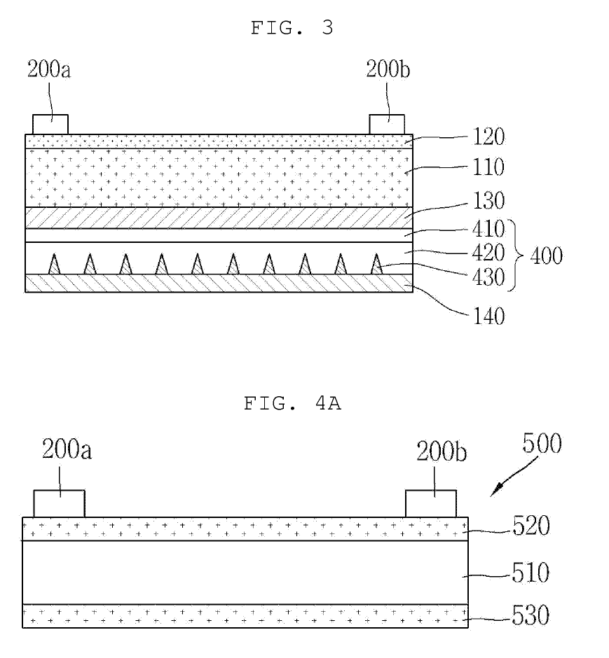

FIG. 1 is a view illustrating a display device having a display filter according to a first embodiment of the present invention, and FIG. 2 is a cross-sectional view illustrating the display filter according to the first embodiment.

The display device according to the first embodiment of the invention includes a display panel 300 and the display filter 100 disposed in front of the display panel 300 to function as an optical filter and an information input device at the same time.

The display filter 100, as illustrated in FIG. 2, includes a layered body and a vibration detector. The layered body includes a base substrate 110, and an optical filter part. The optical filter part includes at least one functional film such as an anti-reflecting film 120, an electromagnetic shielding film 130, a near-infrared shielding film, a neon light shielding film and a color compensating film 140, which is layered on the base substrate 110. The vibration detector is installed on the layered body to detect a touch location by using vibration and thereby receives information input.

The base substrate 110 may be a transparent substrate. In detail, the base substrate 110 may be heat strengthened glass. Further, the base substrate may be composed of transparent polymer resin such as polycarbonate (PC), polyethylene terephthalate (PET) or the like. In the base substrate 110, it is preferable that transmittance to visible light is 80% or more and glass transition temperature is 50° C. or more.

As the base substrate 110, a polymer substrate or a polymer multi-layered substrate may be used. The polymer material may include polyethylene terephthalate (transparent), polysulfone (PS), polyether sulfone (PES), polystyrene, polyethylene naphthalate, polyarylate, polyether ether ketone (PEEK), polycarbonate (PC), polypropylene (PP), polyimide, triacetylcelluose (TAC), polymethyl methacrylate (PMMA), etc.

The base substrate 110 supports respective filtering films, such as the color compensating film 140, the electromagnetic shielding film 130 and the like, and at the same time, undergoes bending from a bending wave. That is, the single base substrate 110 serves as both a support layer for supporting various kinds of filtering films and a touch pad layer for supporting a vibration sensor, thereby reducing the whole thickness of the display device and saving the manufacturing cost.

The vibration detector includes sensors 200a and 200b. The sensors are installed adjacent to the corners of the display filter 100. When an object, for example, a user touches the display filter, the sensors detect vibration generated from the touch location. The controller calculates the touch location by using information transmitted from the sensors 200a and 200b.

Although only two sensors 200a and 200b are depicted in the drawing, generally at least three sensors are needed to determine the position of a touch input in two dimensions, and four sensors may be desirable in some embodiments. In the present invention, the sensors 200a and 200b may be piezoelectric sensors that can sense vibrations indicative of a touch input to the layered body. Exemplary piezoelectric devices may use lead-zirconate-titanat (PZT) crystals.

It is also possible that the sensors 200a and 200b are installed on a surface of the display filter 100 opposite to a touch surface which an object touches to input information. In another embodiment, one or more sensors may be installed on the touch surface of the display filter 100, and the other sensors may be installed on the opposite surface.

Further, the sensors 200a and 200b may be installed on any one of various functional films layered on the base substrate 110.

Optionally, one or more of the sensors can be used as an emitter to emit a signal that can be sensed by the other sensors to be used as a reference signal or to create vibrations that can be altered under a touch input, such altered vibrations being sensed by the sensors to determine the position of the touch. Sensors 200a and 200b can be affixed or bonded to substrate 110 by any suitable means such as by use of an adhesive.

Vibration sensing touch input devices particularly suited to detecting and determining touch position from bending wave vibrations are disclosed in International Publications WO 2003 005292 and WO 0148684.

Piezoelectric sensors are particularly suited for use in devices of the present invention due to their sensitivity, relative low cost, adequate robustness, potentially small form factor, adequate stability, and linearity of response. Other sensors that can be used in vibration sensing touch input devices include electrostrictive, magnetostrictive, piezoresistive, and moving coil, among others.

Piezoelectric elements generally take one of two forms for vibration sensing applications. The first is a unimorph element, which is sensitive to compression in each of its axes. The second is a bimorph element, which is composed of two unimorphs arranged to have opposite polarity and is sensitive to curvature. The choice of which sensor type to use is dependent on the material. When a layered body undergoes bending from a bending wave, for example, the surface of the layered body is placed into curvature and into compression. The ratio of curvature to compression depends on the thickness and stiffness of the layered body. As the layered body is made thicker and stiffer, then for a given frequency and amplitude of disturbance, the curvature decreases (due to a greater bending wavelength) and the surface compression increases (due to the surface being further from the neutral axis). Consequently, unimorph sensors can be more sensitive than bimorph sensors on thicker, stiffer substrates, and vice versa.

Since display devices are typically rectangular, it is typical and convenient to use rectangular touch input devices. As such, the layered body to which the sensors are affixed is typically rectangular in shape. In the present invention, the vibration sensors can be placed near the corners of the layered body. Because many applications call for a display to be viewed through the touch input device, it is desirable to place the sensors out near the edges of the layered body so that they do not undesirably encroach on the viewable display area. Placement of the sensors at the corners can also reduce the influence of reflections from the edges. For a vibration sensor arbitrarily positioned along an edge of the layered body, the signal received due to the touch input event is the sum of the first arrival of the vibration wave packet plus later, delayed reflections of the vibration wave packet from the edges. The proximity of either the sensor or the touch input to an edge of the layered body determines the separation of the direct signal to the first reflected signal. Locating the sensors at the corners increases the separation of the sensor from a possible reflecting boundary, which aids in the separation of the primary and reflected signals for better contact detection.

The shape of the vibration sensors 200a and 200b can also be important. It is desirable the sensor exhibit an omnidirectional response, in other words that the sensor response is relatively insensitive to the direction of vibration propagation. A sensor having a strong angular dependence may undesirably complicate the correlation calculation of touch position from the received signals. To investigate the angular dependence of a piezoelectric sensor's response, the sensor can be driven so that it acts as an emitter. Then, using a laser vibrometer, the outgoing wave can be measured. Angular independence of the piezoelectric device as an emitter can be correlated to expected angular independence of the piezoelectric device as a sensor. Under such analyses, it can be determined that elongated piezoelectric transducers, such as those having elongated rectangular or elliptical shapes, provide better omnidirectionality than square or circular shaped transducers, particularly when affixed at the corner of a substrate. For example, a rectangular transducer, having an approximately 3:1 length to width aspect ratio that is bonded near the corner of a rectangular base substrate of soda lime glass and oriented with its long axis making a 45 degree angle with the edges of the layered body, exhibits a highly symmetric emitted wave when driven.

Related to angular sensitivity is the degree of angular symmetry of the response provided by a sensor. The long axis of an elongated piezoelectric transducer is its axis of greatest sensitivity. By orienting the axis of greatest sensitivity of an elongated piezoelectric sensor to make 45 degree angles with the sides of a rectangular layered body and positioning the sensor near a corner of the layered body, symmetric sensitivity can be obtained. If such a sensor were to point along one of the edges, then vibrations propagating in the direction of that edge may be sensed with greater sensitivity than orthogonally propagating vibrations. By orienting the sensor with its axis of greatest sensitivity at about 45 degrees to the edges, a high degree of symmetry can be achieved, particularly when using an elongated sensor.

The sensor area (length and width), material, and thickness can also be selected to achieve higher sensitivity of the device while satisfying other constraints such as reducing the border area of the touch input device. The sensitivity of a piezoelectric device is determined from an energy argument. On the one hand there is strain energy that is introduced into the piezoelectric element, and on the other hand there is electrical energy that is stored when the capacitive load of the piezoelectric element is raised to a given voltage. Because the piezoelectric effect is efficient, the sensitivity of the device may be determined by setting these quantities equal. Enhancing the sensitivity may be particularly useful when using particularly thick and/or stiff base substrates, such as glass substrates, characteristic of those used in many touch sensing applications. For these types of touch input devices, a contact of a finger or stylus generates relatively small bending wave displacements of the layered body, and thus sensitive transducers are desirable.

Sensor size may be chosen with the following factors in mind. The length and width of the sensors 200a and 200b may be selected so that the sensors do not undesirably encroach on the viewing area. Also of potential consideration is the length of an elongated sensor as compared to the expected range of bending wave wavelengths, if bending wave vibrations are to be sensed for determination of touch position. In the limit where the length of the sensor exceeds the bending wavelengths of interest, the sensitivity of the sensor begins to drop because the motion in the layered body caused by those waves will tend to become averaged out over the length of the piezoelectric element. Exemplary piezoelectric sensors have a length that is generally less than the vibration wavelengths at the highest frequency band of interest. In bending wave applications of the present invention, rectangular piezoelectric sensors having lengths of about 7 mm and widths of about 3 mm may be used, as one example.

The height of the sensor may be selected so that the sensor does not excessively add to the thickness of the display filter, which could complicate the integration of the touch device into a display device. Rectangular piezoelectric sensors having heights of about 1 mm may be used, for example.

In addition to selecting the size (length, width, height) of the bending wave sensors to enhance the strain energy in the material, and thus the sensitivity of the sensor, piezoelectric material formulation can be selected to enhance performance. The material formulation is one factor that determines the capacitance of the sensor, which in turn determines the voltage generated for a given charge. In exemplary embodiment, the sensor material composition can be selected to reduce the dielectric constant, thereby reducing the sensor capacitance and increasing the voltage sensitivity. An exception to this rule may exist under circumstances where reducing the dielectric constant amounts to a reduction in piezoelectric efficiency, in which case the expected gain in sensitivity could be lost. The choice of piezoelectric formulation is therefore preferably made by balancing these concerns. One suitable piezoelectric crystal material is lead-zirconate-titanat (PZT).

The anti-reflecting film 120 is disposed in the front of the display filter facing a viewer to minimize the reflection of external light from the front surface of the display device, thereby preventing display quality from deteriorating owing to reflection.

The anti-reflecting film 120 can be replaced with a hard coating film for protecting the display panel from an external shock. It is also possible that both an anti-reflecting film 120 and a hard coating film are provided together.

The electromagnetic shielding film 130 is provided at the back of the base substrate 100 to block electromagnetic waves. The electromagnetic shielding film may be a conductive mesh film or a multi-layered transparent conductive film in which a metal thin film and a high-refractive transparent thin film are layered on each other.

Here, the conductive mesh film may generally use a metal mesh, a metal-coated synthetic resin mesh, or a metal-coated metal fabric mesh. For the conductive mesh, various metals such as copper, chrome, nickel, silver, molybdenum, tungsten, aluminum, or the like, can be used as long as they have good electrical conductivity and manufactability.

The multilayered transparent conductive film can use a high-refractive transparent film such as Indium Tin Oxide (ITO) to block electromagnetic waves. The he multilayered transparent conductive film may have structure in which a metal film such as Au, Ag, Cu, Pt, Pd, etc. and a high refractive transparent film such as indium oxide, tin dioxide, zinc oxide, etc. are alternately layered on each other.

A thin film composed of silver or silver alloy may be used as the metal film.

Particularly, silver is generally used because it has excellent conductivity, infrared-reflectivity and visible light transmittance. However, because silver has low chemical, physical stabilities and tends to deteriorate by contaminants, steam, heat, light, etc. from a surrounding environment, it is preferred to use silver alloy in which one or more metal elements of Au, Pt, Pd, Cu, Sn, etc. are contained with silver.

The color compensating film 140 can be attached on the back surface of the electromagnetic shielding film 130 so as to reduce or control the amount of light of red (R), green (G) and/or blue (B), thereby changing or correcting a color balance. The color compensating film 140 may contain a colorant which absorbs neon light of orange color.

Generally, visible light of red color emitted from a plasma display panel tends to discolor into orange color. The color compensating film 140 according to the embodiment of the invention absorbs orange light having a wavelength of 580˜600 nm to correct orange color into red color.

The color compensating film 140 may contain various kinds of colorants in order to increase the color reproduction range and color purity. The colorants include, but not limited to, an organic colorant absorbing neon light such as anthraquinone type, azo type, styryl type, phthalocyanine type, methyl type, or the like. Since the sort and concentration of the colorants are determined by an absorption wavelength and an absorption coefficient of the colorant, and transmittance required for a display filter, they are not limited to specific values.

An adhesive film may be provided to adhere the above-mentioned functional films together. The adhesive may include acrylic adhesives, silicone adhesives, urethane adhesives, polyvinyl butylal adhesives (PMB), ethylene-vinyl acetate (EVA) adhesives, polyvinyl ether adhesives, saturated amorphous polyester adhesives, melamine resin adhesives or the like.

FIG. 3 is a cross-sectional view illustrating a display filter according to a second embodiment.

The display filter of the present embodiment has the same structure as that of the first embodiment, but further includes an external light shielding film 400 for absorbing external environment light.

The external light shielding film 400 includes a backing 410, a background 420 formed on one side of the backing 410, and a light absorbing pattern 430 formed at the background so as to block external environment light incident towards the display panel 300. In the present embodiment, the light absorbing pattern 430 includes wedge type black stripes which are disposed at regular intervals from each other.

The backing 410 may be excluded from the external light shielding film 400. The backing 410 supports the background 420 at which the light absorbing pattern 430 is formed. The backing 410 may preferably be a transparent resin film having ultraviolet-transmittance. The backing 410 may be composed of, for example, polyethylene terephthalate (PET), polycarbonate (PC), polyvinylchloride (PVC) or the like.

Of course, other functional films such as the anti-reflecting film 120, the color compensating film 140, the electromagnetic shielding film 130, or the like can be used as the backing 410. The light absorbing pattern 430 has a sectional shape of a wedge and includes the black stripes which are provided on one side of the background 420 facing the display panel 300 at regular intervals, preventing external environment light from entering to the display panel. The backing 420 may be composed of UV-curable resin. The light-absorbing pattern 430 may include black inorganic and/or organic material or black metal which can absorb light. If the light-absorbing pattern 430 contains metal powder, it is possible to control electric resistance according to the concentration of the metal powder and thus, the light-absorbing pattern 430 can also perform a function of blocking electromagnetic waves. Accordingly, the electromagnetic shielding film using blackened or black metal can efficiently perform both an external light shielding function and an electromagnetic shielding function. The light-absorbing pattern 430 can use UV-curable resin containing carbon black.

The light-absorbing pattern 430 can be formed by means of a roll forming method, a heat pressing method using thermoplastic resin, an injection molding method in which thermoplastic or thermosetting resin is injected into an opposite pattern to the light-absorbing pattern 430 formed on the background, or the like. Further, if the UV-curable resin forming the background 420 has an anti-reflecting function, an electromagnetic shielding function, a color compensating function or the combination thereof, the external light shielding film 400 can also have these functions.

The light-absorbing pattern 430 of the external light shielding film 400 blocks external environment light travelling from the outside towards the display panel by absorbing the external environment light but totally reflects display light travelling from the display panel 300 to the outside without absorbing the display light. Thus, high transmittance to the display light and high contrast ratio can be obtained.

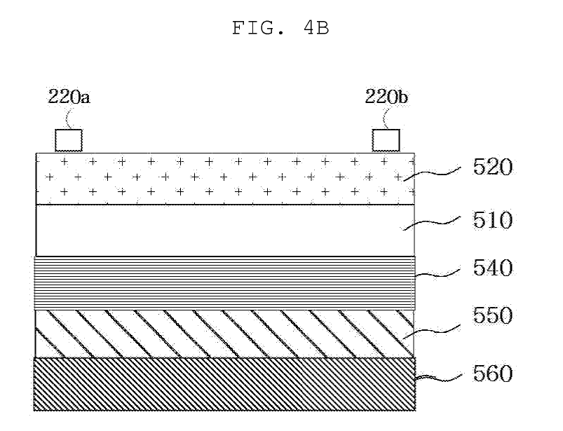

FIGS. 4A and 4B are cross-sectional views illustrating display filters according to third and fourth embodiments.

The display filter 500 according to the third and fourth embodiments is a filter (a protecting plate) which is applicable mainly to a Liquid Crystal Display (LCD), and has the structure in which a vibration-detecting touch input device is integrally provided. Of course, the display filter 500 is also applicable to any other display devices.

Referring to FIG. 4A, the display filter 500 having a touch input detecting function includes a layered body and sensors 200a and 200b. The layered body includes a base substrate 510, a first anti-reflecting film 520 provided on one surface of the base substrate 510, and a second anti-reflecting film 530 provided on the other surface of the base substrate 510. The sensors 200a and 200b are installed on the layered body to detect the touch location through vibration and receive information input.

The first anti-reflecting film 520 and second anti-reflecting film 530 can be joined to the base substrate 510 by means of an adhesive layer or the like.

Here, the base substrate 510 serves as a protecting plate for the LCD panel and a touch plate for the sensors 200a and 200b.

The sensors 200a and 200b are identical to above-mentioned sensors, so the description thereof will be omitted. The sensors 200a and 200b can be installed on at least one of the base substrate 510, the first and second anti-reflecting films 510 and 520. For example, some sensors can be installed on the first anti-reflecting film 510 and the other sensors on the second anti-reflecting film 520. Or, some sensors can be installed on the base substrate 510 and other sensors on the first and second anti-reflecting film 510 and 520.

Referring to FIG. 4B, the display filter 500 having a touch input detecting function includes a layered body and sensors 200a and 200b. The layered body includes a base substrate 510, an anti-reflecting film 520 provided on one side of the base substrate 510, and a conductive film 540, an adhesive film 550, and an anti-fog film 560 provided on the other side of the base substrate 510. The sensors 200a and 200b are installed on the layered body to detect the touch location through vibration and receive information input.

The conductive film 540 may use a multi-layered film in which a metal thin film and a high-refractive transparent thin film are layered two or more times on the surface of the base substrate facing the display panel. The metal thin film is composed of Au, Ag, Cu, Pt, Pd, etc. and the high refractive transparent thin film is composed of indium oxide, tin dioxide, zinc oxide, etc. Particularly, the metal thin film is preferably composed of silver or silver contained oxide, which has excellent conductivity, infrared-reflectivity, and visible light transmittance.

The anti-fog film 560 prevents the display filter from becoming fogged by moisture in a space between the display panel and the display filter. As an example, the anti-fog film 560 may use a polyester film with a hydrophilic coating layer which is formed using water, polyvinyl pyrrolidone and surfactants.

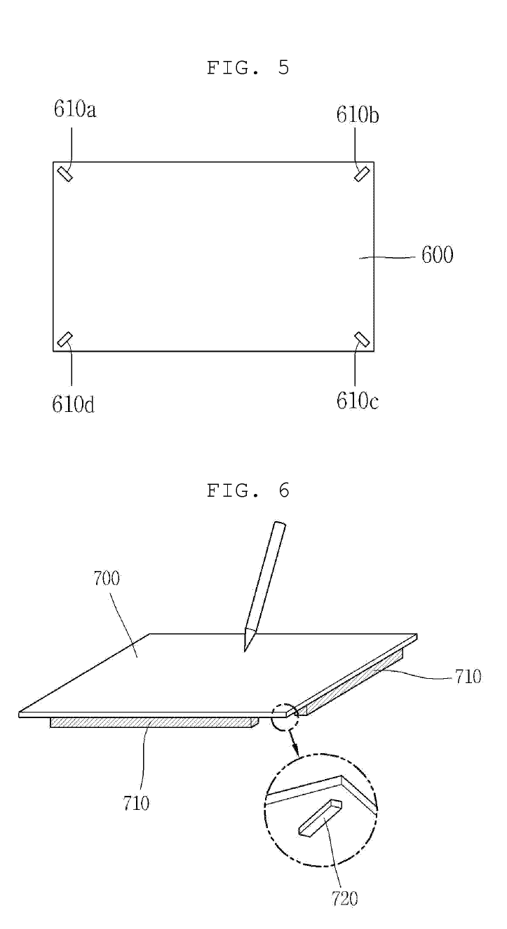

FIG. 5 is a front view illustrating an example of a sensor which can be used in a display filter of the present invention.

The display filter includes rectangular piezoelectric sensors 610a, 610b, 610c, and 610d which, if the display filter 600 is rectangular, are positioned adjacent to four corners of the display filter 600.

The sensors may be oriented with their respective axes of greatest sensitivity lying along 45° with the adjacent edges of the display filter 600.

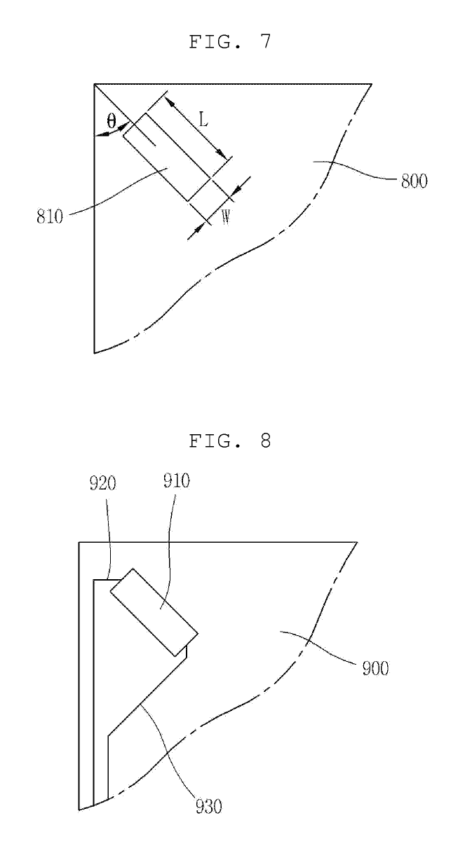

FIG. 6 is a perspective view illustrating an example of a sensor which can be used in a display filter of the present invention, wherein the sensor 720 is installed at a corner of the display filter, and a foam mounting 710 is attached along edges of the layered body.

The foam mounting 710 has adhesive surfaces whereby the display filter may be securely attached to any surface. The foam mounting may reduce the reflections from the edge of the display filter. As shown, piezoelectric vibration sensors 720 can be rectangular and can be mounted so that their long axes point toward adjacent corners of the display filter 700.

The display filters 600 and 700 of FIGS. 5 and 6 may be any one of display filters according to the first, second and third embodiments, and the sensor may be the piezoelectric vibration sensor as described in the first embodiment.

FIG. 7 is a partial front view illustrating an example of a sensor which can be used in a display filter of the present invention. The sensor 810 can be characterized by its length L, its width W, and its height, or thickness, (not indicated), as well as by its position relative to the corner of the display filter and by the angle that its axis of sensitivity makes with an edge of the substrate.

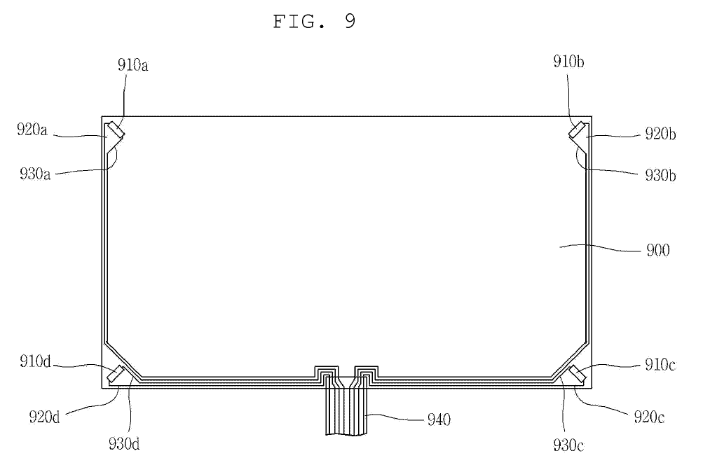

FIG. 8 is a partial front view illustrating wires for a sensor which can be used in a display filter of the present invention.

A pair of wires 920 and 930 is respectively printed on the display filter 900, to electrically connect the sensors 910 which are installed at the corners of the display filter 900 to a controller.

Here, the wires 920 and 930 may be preferably printed along the edges of the display filter 900 so that they do not block an effective display screen on which an image is displayed.

When the sensor 910 is stressed under the influence of a vibration propagates in the display filter under the influence of a discrete touch, a charge gradient is created in the piezoelectric material, causing a voltage drop through the thickness of the material. By connecting wires 920 and 930 to electrodes on the top and bottom of the piezoelectric sensor, this signal can be communicated to the controller (not shown) for computation and interpretation of the signal to determine touch position. Piezoelectric devices are available where the electrode on one side of the device is wrapped around to extend slightly onto the other side of the device so that the wires can be more conveniently connected due to both electrodes being accessible on the same side of the device.

FIG. 9 is a front view illustrating wires and tail arrangement for sensors. The sensors 910a, 910b, 910c, and 910d installed at the corners of the display filter 900 are connected to the respective pairs of wires 920a and 930a, 920b and 930b, 920c and 930c, and 920d and 930d. Each pair of wires extends along an edge of the display filter 900 to an area where the tail 940 can be connected. The tail 940 can provide a convenient means of connecting the wires to the controller (not shown) that determine and report the location of a touch input using the information gathered from each of the sensors from sensing bending wave vibrations due to the touch.

While for convenience of explanation, the PDP filters and the LCD filters have hitherto been described, the present invention is not limited thereto. The vibration-detecting display filter of the present invention is applicable to various filters for any other display devices.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A touch input detecting display filter for a display device having a display panel therein, the touch input detecting display filter comprising:
a layered body comprising a base substrate disposed in front of the display panel, and an optical filter part having an anti-reflecting film layered on the base substrate; and
a vibration detector disposed on the layered body, the vibration detector detecting vibration generated from a touch location of the layered body when an object gets in touch with the layered body.

2. The touch input detecting display filter according to claim 1, wherein the optical filter part further comprises at least one of an electromagnetic shielding film, a near-infrared shielding film, a neon light shielding film, and a color compensating film which is layered at a side of the base substrate facing the display panel.

3. The touch input detecting display filter according to claim 1, wherein the optical filter part further comprises an electromagnetic shielding film layered at a side of the base substrate facing the display panel and an external light shielding film layered on the electromagnetic shielding film to absorb external environment light.

4. The touch input detecting display filter according to claim 1, wherein the optical filter part further comprises a conductive film in which a metal thin film and a high-refractive transparent thin film are layered two or more times, at a side of the base substrate facing the display panel.

5. The touch input detecting display filter according to claim 1, wherein the optical filter part further comprises an anti-fog film layered facing the display panel to prevent the display panel from fogging by moisture present in a space between the display panel and the touch input detecting display filter.

6. The touch input detecting display filter according to claim 5, wherein the optical filter part further comprises a conductive film in which a metal thin film and a high-refractive transparent thin film are layered two or more times, at a side of the base substrate facing the display panel.

7. The touch input detecting display filter according to claim 1, wherein the vibration detector comprises a piezoelectric sensor installed adjacent to a corners of the layered body to detect the vibration.

8. The touch input detecting display filter according to claim 7, wherein the four piezoelectric sensors are installed adjacent to the four corners, respectively.

9. The touch input detecting display filter according to claim 8, wherein at least one of the piezoelectric sensors acts as a vibration emitter.

10. The touch input detecting display filter according to claim 7, wherein wires connecting the piezoelectric sensor to a controller receiving a vibration detecting signal from the piezoelectric sensor and calculating the touch location are printed on the layered body.

11. A display device comprising:
a touch input detecting display filter; and a display panel emitting display light through the touch input detecting display filter,
the touch input detecting display filter comprising:
a layered body comprising a base substrate disposed in front of the display panel, and an optical filter part having an anti-reflecting film layered on the base substrate; and a vibration detector disposed on the layered body, the vibration detector detecting vibration generated from a touch location of the layered body when an object gets in touch with the layered body.

12. The display device according to claim 11, wherein the vibration detector comprises a piezoelectric sensor installed adjacent to a corner of the layered body to detect the vibration.
